(19) United States
(12) Patent Application Publication
(10) Pub. No.: US 2006/0129421 A1
(43) Pub. Date: Jun. 15, 2006

(54) Business method for novel ideas and inventions evaluation and commercialization

(76) Inventor: Oleg Matveev, Gainesville, FL (US)

Correspondence Address: Oleg Matveev, 1212 NW 90 th Drive, Gainesville, FL, 32606, US

(21) Appl. No.: 11/295,822

(22) Filed: Dec. 6, 2005

Related U.S. Application Data
(60) Provisional application No. 60/634,775, filed on Dec. 10, 2004.

(51) Int. Cl. G06Q 99/00

(52) U.S. Cl. 705/1

(57) ABSTRACT

A novel business method of novel ideas, inventions and scientific proposals evaluation and commercialization is suggested. A private, government or universities supported (virtual from the very beginning) an Internet connected agency (entity) open for every scientist has to be created. Every scientist can submit his IIPs to the agency and can become a member of the agency. Every member can participate in evaluation and review of any submitted IIP. All members should sign nondisclosure/nonusage agreement. According to this agreement, during a predetermined a period of time any info from the agency database cannot be disclosed to anybody (except the members), used in any way or explored by a member without permission of an author. All reviewers will be ranked by the agency. All submitted IIP also will be ranked and presented for sale on the web sites of the agency. The rank of the reviewers will depend on their ability to predict long term fate of submitted to the agency IIPs.

### CROSS-REFERENCE TO RELATED APPLICATION

The present application claims the priority of U.S. provisional application U.S. 60/634,775 entitled “Business method for novel ideas and inventions commercialization” filed Dec. 10, 2004.

### BACKGROUND OF THE INVENTION

1. Field of the Invention

The present invention relates to Internet based business methods for novel ideas, inventions and scientific proposals evaluation and commercialization.

2. Introduction

There exist many signs indicating that U.S. is losing its scientific and technological leadership and competitiveness. See, for example, web sites: http://www.futureofinnovation.org/ http://www.futureofinnovation.org/PDF/Benchmarks.pdf; New York Times articles: US Is Losing Its Dominance in the Sciences. By WILLIAM J. BROAD, May 3, 2004; Are US innovators Losing Their Competitive edge?, by Timothy L. O'Brien, Nov. 13, 2005; Physics Today Online, Dec. 2, 2005, http://www.physicstoday.org/vol-58/iss-12/p25.html, ‘Gathering Storm’ Report Urges Strong Federal Action to Save US Science and Technology Leadership, by Jim Dawson. “The authors of the report, including physics Nobel laureates Steven Chu and Robert Richardson, were blunt and specific in their responses. The ” scientific and technical building blocks of our economic leadership are eroding at a time when many other nations are gathering strength,“the report says ”

Despite of these evident facts that “U.S. is losing its scientific and technological leadership and competitiveness” America still has powerful scientific enterprise with tremendous reserves for improvements. One of the way to increase the U.S. competitiveness is by advancing the science organization and management system and to improving the system of novel ideas, inventions and scientific proposals (IIP) evaluation and commercialization. Hundreds and thousands of books and articles offer many original ideas worth to be studied. Some of the ideas if implemented can provide considerable progress to improve the whole science management system and to eliminate its imperfections, flaws and deficiencies. However, the real progress in eradication of these deficiencies is rather slow or may be even in the state of almost perpetual stagnation. If scientific enterprise is not organized optimally the process of novel scientific ideas, inventions and proposals evaluation and commercialization become unacceptably slow, selectivity in choosing the most promising IIP is far from being optimal.

If people invest in science, they expect that their money will be spent in the best of their interests. There are many ordinary people, scientists, politicians who suppose that modern science management system is actually designed for these purposes. However, not everyone believe that this is true and that all elements of existing system for science and IIP management are primarily designed to serve for the benefits of the Investor and for the scientific progress. Many indications of this disbelief can be seen in the literature. “In tens of thousands of books and hundreds of thousands of journal articles, they have perverted the system of academic publishing into a scheme that serves only to advance academic careers and bloat libraries with masses of unread, unreadable, and worthless pabulum. . . . They have constructed machinery that so far has frustrated or sabotaged every effort at meaningful reform that might interfere with their boondoggle.” [1]. Physicist prof G. Khromov in his book “The science which we are loosing” wrote [2]: “It will not be exaggeration to say that the main forms of science organization had not been changed for almost five centuries.”

The main reasons that all efforts to change the system had been sabotaged are analyzed in detail in many books and articles [See, for example, 1-8]. Briefly formulated these reasons can be expressed as following: the American model for science support and management system, and apparently to the much greater extend the systems of any other country, implanted into the methodology of management too much of romantic socialism. “America's academic intellectuals work in a quasi-socialist state, while our professional intellectuals, for the most part work under bare-knuckle capitalism. . . . America's academic intellectuals are largely insulated from the discipline of free markets, each university or college a tiny oasis of quasi-socialism [3].” As it is well known from the history of Soviet-block countries, unavoidable satellites of any socialist system are lie, corruption, dishonest and unfair competition, which from certain moment stalled, nullified any efforts to revive and to make more efficient their economy and science. Huge financial and human resources were invested into scientific research to fix the Soviet socialist economic and science management system. However, everything was in vain. The system was incorrigible and it has perished loosing economical competition.

The capitalism has won the economic competition mainly because of the two reasons. First of all, it provided much clearly formulated, fair and honest rules of intellectual competition for entrepreneurs and companies; secondly, people and companies have much more degrees of freedom to do business. The same as in the economy, the norms of honest and fair competition are extremely important constituents in the design of contemporary science and IIP management system. The reflections and results of this competition are normally seen in career achievements and the rank of a scientist. However as known, “Most academics, ” a 1987 report by the Economic Policy Institute concluded, “live in a world whose incentives have nothing to do with economic competitiveness[1]. It needs to be added that their incentives also have nothing to do with real intellectual competition. Real competition in science theoretically has to be based on evaluations of real personal achievements of scientists, but instead of it, irrelevant and subjective factors play inadequately colossal role in the career of scientists. As seen in the literature [1-8] and in the real scientific life, the career, promotions and rewards of scientists depend on many factors:

1. Ability, skill, talent of scientists to raise the money for research.

2. Number of published papers, books, patents etc.

3. Number and prestigiousness of scientist's awards and prizes.

4. His loyalty to his peers, superiors and to the existing system of science management.

5. How good he/she is as a teacher, writer, speaker, orator, and lecturer.

6. What kind of service and how often it is performed for academic journals, university and various committees, foundations, city community etc.

7. Connections.

8. Personal wealth.

9. The university from which you were graduated. (Pedigree requirement or it is called sometimes academic pedigree).

10. Who was your Ph.D. advisor/professor in graduate school?

11. Ethnic roots.

12. Gender.

13. Race.

14. Age.

15. Your country of origin and citizenship.

16. How well the person gets along with his colleagues. (Collegiality).

17. Ability, when it is necessary, to be politically correct, obedient and malleable.

18. Membership in societies and academies.

19. How many Ph.D. students are graduated under your supervision.

20. Emotions about you of your colleagues, friends, bosses, chairs, presidents, directors, students, faculties, staff members, members of various scientific committees, members of academies, scientific societies, etc.

21. How good is your communication skill.

22. How long have you been working at the institution, where your current job is.

23. Person's appearance, personality, character.

24. How good you are in demonstrating to look important, VIP, pompous.

25. How good you are in catching on time, understanding and following nowhere written the rules of the game in science. You never can find them written anywhere. They can be very different in different places and in different fields of science. Some of these unwritten rules do not look as very honorable. “Ones you passed the Ph.D., the rules for scaling successive steps become increasingly less well defined. The rules are often unwritten, and people you must impress are further afield” [9].

26. How good you are in following the written norms of ethics and moral conduct, which are sometimes very contradictory and very often directed to give unjustified advantages for scientists who have already power, money and established position.

27. How valuable for the country, society, people, for the mankind is a new scientific knowledge obtained with your participation and published with coauthors.

28. How valuable for society, for people, for the mankind is a new scientific knowledge personally obtained by a scientist.

29. How good you are in reviewing, evaluating and interpreting new scientific ideas and knowledge obtained by other scientists.

30. How secure is your boss's position within the institution where you work and within a scientific community of a country and internationally.

31. How lucky is a scientist/professor to attract talented graduate students, postdocs, and other scientists to work with him.

32. Number of graduate students, postdocs and scientists who worked and are working for you.

33. How big and well equipped is a laboratory where you work.

34. How prestigious is the institution where you work.

35. How good you are in playing the game: “I have a job offer from another institution.” (Sometimes it is also called academic chicken game).

36. Serendipity. A pure luck and accidental discovery. Jackpot in the scientific lottery.

Certainly not all factors influencing somebody's scientific career are listed here. It is evident that all of these factors except # 28, 29 are either absolutely or to a great extend are irrelevant. I.e. theoretically they do not have to have any influence on scientists' visible rank, career and rewards. It is evidently the more society underappreciate real personal contribution of scientists the more errors will be made to determine the rank of scientists, and more IIP-scientific garbage will be produced by science. It is understandable that the degree of uncertainty in determining the rank of scientists is directly relevant to the degree of uncertainties in determining the value and significance of newly suggested inventions, ideas and proposals of scientists. Common sense tells us that all of these irrelevant factors must not have any tangible influence on scientists' rewards from society. However, in real life not everything is so ideal. Of course, the influence of different factors is very different depending on the field of science, country, university, department, even scientific group etc. In some places, universities or countries some of them are negligible. Somewhere the irrelevant factors are unacceptably influential.

To reveal who is who in science first of all we have to understand what kind of personal contribution of scientists has to be taken into account. It is well known that any new science as a rule arise, emerge from a new original idea, which only on very rare occasion can be generated simultaneously by more than one person. Further on the idea has to be developed to the level first of all understood by at least one another scientist. I.e. he has to conclude that the idea and a scientific results which can follow from the idea are scientifically plausible, correct, worth studying it might be developed further. There are four main cases an idea and its development prospects.

First, the idea is nontrivial the same is development, i.e. to generate and to develop the new idea both are ill structured scientific tasks. As an example of this sort of science was the invention and development of atomic bomb.

Second one: the idea is trivial, however development is very ill-structured. In the world of modem physics also some examples can be found like a weapon based on annihilation of matter and antimatter or laser weapon for “the Star Wars”.

Third: the idea is nontrivial, however development is rather well-structured and understood by many scientists almost simultaneously what can and has to be done to extend it further. One of the example, of such a science is recognized by Nobel prize the discovery and development of electrospray ionization source for mass spectrometry.

Fourth: trivial idea and rather trivial well-structured development. Most of the modem scientific works belongs to this fourth category.

Thus it is understandable, to rank a scientists, first of all we have to know what trivial/nontrivial ideas and developments had been done by them. Let us analyze what can be done for that. Recently such a system has been introduced by some scientific journals. For example, for papers sent to medical journals JAMA, BMJ, Lancet there is a requirement to indicate a real personal contribution of every coauthor. For the sake of fairness it needs to be emphasize two things. First of all that such an experiment to indicate a personal contribution had already been established long ago by the Soviet patent system, where all coauthors were required to indicate their contribution into invention. And second that this requirement was easily overcome by nonscrupulous scientific managers. They regularly had been included as coauthors despite their not so rare zero contribution into invention. It is well known that this happened because the fate of invention and real inventors depended much more on the will of managers than on their real scientific contribution. For example, in the era of the Internet it is very easy to safe and to store the ideas of everyone with potentiality to watch and evaluate them by everyone in the world. It looks very strange why this practice is not accepted as widely as it has to be? There are many strange reasons for that. One of them, for example, because it is against the interests of existing PhD producing university system. Not so rare well being of many research universities depends not only on the quality and worthiness of their scientific research but also on the number of PhD students graduated by them. When there are a lot of postdocs and graduate students for professors in this case the benefits even tripled: first of all the more very poorly paid graduate students in the group the more people can do routine ( often nonrelated to real scientific research) drudgery research and pseudo-research work. Secondly, the more students the more publications can professor have and therefore much better prospects for his rewards and carrier at the university. Thirdly, when there is no system indicating real contribution not so rare all credits for research work, done by students postdocs and scientists in professor's lab, goes to him, even if he did not participate scientifically in some important research work. “The Matthew Effect in science is the observation that credit tends to go to those who are already famous, at the expense of those who are not. For example, if a paper is written by a group of authors, only one of whom is well known in the field, readers will automatically assume that person is responsible. A paper signed by Nobody, nobody, and Somebody will be casually referred to as “work done in Somebody's lab,” and even sometimes cited (incorrectly) in the literature as due to “Somebody, et al. ” [9].

In many fields of science journals do not require to indicate personal contribution of every author. In this case only on very rare occasions one can find out, extract or dig up the information about the real value of personal scientific contribution of a scientist. This can happen, for example, if a scientist has at least one original, valuable publication (paper, patent etc.) written without coauthors with new, nontrivial result, idea or concept suggested solely by him. Unfortunately, works like these especially in experimental science more and more often become rather an exception than a standard scientific practice. When a scientific paper is written by many co-authors quite often we do not know exactly what is real contribution of anyone of them. More over as it is well known instead of generating real valuable scientific knowledge the modern science is still in the mortal grasp of pernicious paradigm “publish or perish”. “The academic intellectuals have developed such a tight-knit scheme of intellectual logrolling that their evaluations of the merits of scholarly work have become, for the most part, worthless-especially those based on article or citation counts. There need to be strong reemphasis on quality-on the importance and relevance of research and writing-instead of quantity[3. ]

Of course, in any country, university, scientific institution in the world there exist certain system, which helps to determine the rank and based on it the reward of scientists. Interestingly that practically all industrialized and many other countries have much more similarities than differences in the designs of their systems. Trying to summarize the main constituents of these systems we can find that they are based on three independent to some extend tables of ranks of scientists and scholars.

1 Ph.D. degree. Only the meaning of this word, which is the Doctor of Philosophy, can cause confusion and suspicion that something is not OK with this system of scientific rank attestation. Several centuries ago may be all scientists had been to some extend philosophers but not now. More over if we try to analyze a little bit deeper what persons are hidden behind the PhD label we can find that they sometimes can dramatically differ from each other. Even from the same university, even from the same scientific group. From one side this might be an intellectually autonomous, independent, self taught almost accomplished scientists who before going to graduate school suggested his own world-class novel scientific idea, formulates by himself a plan for his research work and develops it with minimal help from his professor-supervisor. From another site a student who worked on his professor's rather simple, trivial ideas, demonstrating only minimal level of self-sustainability and very slow movement towards scientific goals formulated by his supervisor. ” “You don't have to be a major intellect to get a Ph.D. The most important characteristic you usually need is dogged determination.” [5]. Different countries, universities, departments even scientific groups have very different criteria and thresholds to be graduated as a Ph.D. Taking into account all of this reasoning it is very clear that PhD degree gives very little clue about real potential of scientist to be as a generator of new ideas or their reviewer. Due to this when hiring scientists practically always no one employer relies on the PhD label, trying to get references and heavily relying on the interview with candidate for a job.

2. Professorship, faculty at university. When young scientist is applying for tenure-track assistant professor position in a university as a rule no one asks him what new original ideas, research directions where generated, initiated personally by him, what is his personal scientific contribution and impact of his personal contribution on science or/and practice. Mostly what plays role is his academic pedigree, the age of applicant, who was his scientific supervisor, what it is said about the applicant in references, how many paper where published, how was his scientific presentation [5,17]. Working towards tenure professor position every one realize that to direct himself towards generating very new, original science is very risky business. It is a sort of gambling. You can try to generate something valuable for 5-6 years and get nothing. Much more promising is to start with something routine what is everywhere in the scientific journal and in the media as a new and promising topic, publish 10 -12 papers during 5 -6 years, get couple of grants while seeking tenure and you are very safe. New tenure professor is born never proving to the world that he is capable of doing something original. If for some reason he is not lucky further in his career in finding really something new and original he might will fiercely oppose to any new system objectively evaluating real contribution of a professor-scientists. He might will be a fierce proponent of the system where the number of publications counts more than their worthiness. As can be understood from this short essay and from the literature [1-5] the label of being professor not so rare also does not provide much information about the real rank and contribution of scientist.

1. Membership in elite academies and societies. Apparently, for scientists in the United State one of the most prestigious accomplishment is to be elected in the National Academy of Science (NAS). On the Internet site of the NAS they claim that “election to membership in the National Academy of Sciences is considered one of the highest honors that can be accorded a U.S. scientist or engineer. Academy of science recognizes those who have made distinguished and continuing achievements in original research”. A lot of panegyrics about the NAS can be found in the literature. Founded in 1863 to provide learned advice to the federal government, the National Academy of Science ranks second only to the Nobel Prize in prestige ” [4]. “Outside the Nobel prize, there is nothing that is more universally accepted as a credential of significance than membership in the academy, ” said Eminent Scholar Robert Cousins, who become an NAS member in 2000 [16]. Unfortunately, not so much can be found how personal contribution of scientists is measured to be elected to the NAS. New academy members are elected by current ones in a secretive, lengthy and rigorous nomination process, and some have complained the closed loop favors institutions that already have substantial membership [16]. Why so many secrets? Why should we believe that the members of the NAS are really the best scientists in America or may be in the world if we even do not know how and based on what criteria new members are elected? How do they look at present and in the past, for example, as generators of new original ideas and hypothesis in comparison with nonmembers? How good and fast they are in recognizing new promising scientific ideas, proposals, directions. By whom and how it had been determined that they are the best? What was the methodology for determination of their rank? I am sure there are many of them who are actually the best in the world in what they are doing in their area of science. But we have to know more exactly they are best in what: to generate new ideas, to evaluate them, to develop them or something else? Had they been the best in the past or/and the best at present. Should not we be suspicious that there are many of them who might never had been the best or even the second? Yet another thing what make everybody suspicious about Academies. About this contradictory fact one can read or hear very often. Still there is no logical, explicit answer, how professional in one area, let us say biologist can elect professionals from another area let us say physicist? How can they understand the rank of somebody who never worked in the area of their expertise?

Not only flattering panegyrics one can read about the NAS. Sometimes we can hear sarcasm “If they aren't electing their colleagues,” Young (president of the University of Florida) said “they're electing their students” [16]; “by far the most important thing the NAS does is to elect its own members.” [5]. Something similar in tone described in [21 ] about election into the Russian Academy of Science. Newly elected member cynically comments his own election: “ . . . I thought to be elected to the Academy one has to be devoted to science. Now I can see that one simply has to be acquainted with many academicians.”

This brief analysis of scientist's tables of rank shows that the existing system provides not so much credible, trustworthy information about who is who in the science and who is the best Gld, reviewer or scientific ideas developers etc. Even worse is the situation with the information about ability of scientists to be effective reviewers and evaluators of scientific ideas and proposals. Practically all scientific reviewing is anonymous. No one knows and no one keeps and analyzes the information, for example, who was the first one to recognize great scientific ideas or who made mistakes in evaluating promising important proposals of other scientists. The information about scientist's ability to be an effective reviewer of scientific proposals and ideas, as a rule, has very minuscule influence on his career and rewards. This paradoxical fact does not have any logical explanation. It is one of the greatest puzzle of the modem American and the whole scientific world: how in existing system, which very often does not provide any reliable clue who is who in science, one can determine salaries, rank, rewards, fate of scientists and their IIPs?

As we mentioned before, the degree of uncertainty in determining the rank of scientists is directly relevant to the degree of uncertainties in determining the value of the IIP. The more subjective and irrelevant factors play role in the fate and career of scientists the longer it takes for the system to recognize the most valuable and promising ideas and much more redundant information and noise is produced by science. As mentioned by Donald Kennedy [cited from 3], president of Stanford University “. . . The overproduction of routine scholarship is one of the most egregious aspects of contemporary academic life: It tends to conceal really important work by its sheer volume: it wastes time and valuable resources.”

The same idea is expressed by many others scholars, for example, provost of the University of California at Santa Cruz Page Smith [cited from 3]: “The vast majority of the so-called research turned out in the modern university is essentially worthless. It does not result in any measurable benefit to anything or anybody. It does not push back those omnipresent “frontiers of knowledge” so confidently evoked. . . . It is busywork on a vast, almost incomprehensible scale. It is dispiriting; it depresses the whole scholarly enterprise; and ... most important of all, it deprives the student of what he or she deserves-the thoughtful and considerate attention of a teacher deeply and unequivocally committed to teaching.”

It needs to be noted that the idea to use the Internet to sell ideas and other intellectual property is not novel. See, for example, web site www.yet2.com and www.newideatrade.com. The Yet2.com company is simply connecting sellers and buyers of well established technology through the Internet, but it does not evaluate the technologies and sells them as it is. The Newtradeidea.com also helps sellers and buyers of ideas to find each other. The ideas are also not evaluated and presented without their rank. Potential buyer has to spend so much time to find detailed description of the idea and evaluate it by himself.

Drawbacks of the existing science management and the IPP evaluation and commercialization system.

More generally the drawbacks and flaws of the existing science management and IPP evaluation systems can be expressed as follows.
1. Too much time, mental energy and scientists' talents are spent worthlessly to advance in their scientific careers. The intellectual potential of scientist is used very ineffectively since they have to be simultaneously, generators and developers of new scientific ideas, fund raisers, teachers, lecturers, managers and writers of scientific projects, writers of books and articles, free of charge different type of service provider. Scientists have to waste a lot of time for “marketing” and “selling”0 their ideas.
2. The science produces too much worthless, redundant information, the further the more. The ratio worth/worthless become less and less.
3.The precision with which scientists' valuable contribution to the world scientific knowledge database is measured is unacceptably poor. The reward system is highly subjective, generates many mistakes and it is logically contradictory.
4.The scientific system is closed. Not every scientist has equal access to the finds to check his ideas even if his ideas have rather high potential value.
5.The number of good, worth studying further ideas, grows much faster than the ability of the system to digest and experimentally/theoretically to check them.
6.The system is very slow to accept and to develop new ideas, inventions and scientific proposals. It is especially slow in the field of purposive fundamental science which is between fundamental and applied science. Unacceptably slow, very expensive, making too many mistakes and nonselective is a patent system.

### The Goals of the Invention. [032]

1. To provide better precision and speed in evaluation of new promising ideas, inventions and scientific proposals with commercialization potential.
2. To advance and accelerate scientific progress and consequently the progress of economy.
3. To provide the realization of a new principle of scientific policy: “Equal opportunity for equally good scientific ideas.”
4. To increase the speed of development and commercialization of new promising ideas, inventions and scientific proposals.
5. To provide more precise evaluation of intellectual ability and potential of inventors, scientists and science managers.
6. To improve the quality of teaching at universities.
7. To improve the efficiency of the intellectual capital and resources usage.
8. To improve the degree of fairness and precision in rewarding of scientists for their achievements.
9. To improve the degree of intellectual property (IP) of scientists protection. To decrease the probability for IP to be stolen, pirated or/and used without appropriate acknowledgement.
10. To eliminate the waste of time, energy and money to create new businesses, when it is not necessary for the authors of scientific idea.
11. To increase the degree of scientific enterprise openness. To make it more resistive to corruptive forces of “old boys' network”.
12. To decrease the time Which is necessary to determine the rank of scientist. To increase precision and to decrease the time , which is necessary to determine the rank of generators of new scientific ideas (Gld) and reviewers of scientific proposals.
13. To improve the ability of the science management system for self-improvement.
14. To decrease a waste of money and the probability to be funded for the pseudoscientific projects.
15. To increase the speed, quality and productivity of experimental work and decrease the price tag for experiments.
16. To achieve better level of job security for creative and efficient GIds and reviewers.
17. To decrease a scientific wasteland and the informational noise. To get rid from the scientific environment pernicious paradigm “publish or perish.”
18. The decrease the pernicious influence of “pathological decentralization” of the U.S. science.
19. To help finding the best managers, CEO at younger age who demonstrate the ability to generate valuable new ideas and ability to solve sophisticated, ill-structured managerial and scientific tasks.
20. To create for scientists the reliable, trustworthy feedback, quickly showing their successes and failures, helping them quickly reorient their efforts towards more promising, more advanced science.
21. To eliminate the signs of pathological rivalry appearing in the competition between developers of scientific projects and GIds.
22. To eliminate for good creative scientists the waste of time trying to find a job.

To decrease the probability that good, established scientists will be thrown away from the scientific market, i.e. to decrease the bad chance influence on career of efficient, creative, established scientists.
23. To begin a new era in science when everyone can tell the truth without fear being punished. To end the era in science when a whistle-blowers telling the truth are penalized.

### SUMMARY OF THE INVENTION

Instead of four well known Mertonian norms governing modem science (universalism, organized skepticism, communism, and disinterestedness), which apparently are derived from the communism ideology, the only one norm is suggested: equal opportunity for equally good scientific ideas.

A private, government or universities supported (virtual from the very beginning) an Internet connected agency (entity) open for every scientist has to be created. Every scientist can submit his IIPs to the agency and can become a member of the agency. Every member can participate in evaluation and review of any submitted IIP.

All members should sign nondisclosure/nonusage agreement. According to this agreement, during a predetermined a period of time any info from the agency database cannot be disclosed to anybody (except to the members), used in any way or explored by a member without permission of an author.

Periodically all reviewers and all evaluated IIPs will be ranked by the agency. The rank of reviewers depend on the real fate of the IIP, which was analyzed by them. All reviews are onymous.

After evaluation every idea, invention or proposal will have a team of open opponents and open proponents. Within the entity the author of IIPs have all exclusive rights and ownership during predetermined period of time. The predetermined time will last life time of the author plus predetermined number of years.

Authors of the IIPs will be free to sell, to disclose, to patent, to gift or endow them. All IIPs evaluated by reviewers as novel or not novel, obvious or not obvious, and if it is worth or not worth to study or develop them further. The IIPs will have highest rank if it is evaluated positively by reviewer or revivers with highest rank.

The preliminary rank of the reviewer will be determined based on correlation of the results of his review with results and opinions of previously certified reviewers and the experts, and the finale rank of the reviewer will be determined based on objective data about a finale fate of submitted to the entity IIP.

### BUSINESS METHOD DESCRIPTION

Every new scientific knowledge begins from an idea, the value of which in the beginning can only be understood by an author. The idea can further be developed into an invention, scientific fact, theory etc understood by many other scientists, inventors, engineers, investors. Sometimes millions or even billions of dollars should be spent on the scientific research to check and to develop the idea before private investor can feel secure to support its further development and commercialization. In his decision to provide financial support the investor very often is oriented on the existing peer-review system, the experts-reviewers opinions and evaluations. As it was shown above the existing peer-review and the system for scientists-reviewers ranking is a total mess. We do not know exactly who is who in science and therefore can not know exactly what is what about ideas. Due to this it takes on average to spend too much time and money to develop an idea to the level from which a private investor might agree to risk his money for further development.

The most important novelty of this new system is incorporation of more than hundred years old, however never realized, suggestion about much higher level protection of novel scientific IIPs, with a new way of their protection. The level of protection in principle can be from zero (i.e. like it is at present) to a perpetual absolute ownership, like for example, the ownership of stocks. It is understandable that main reason why the ideas are not protected by law are not scientific, but rather more of political and cultural nature 10. Even in XXI century the common sense of not only ordinary people, but also majority of scientists, unfortunately, has not reached the necessary stage of understanding and acceptance of this rather simple ideology about better protection of ideas and proposals. . . .“Society offers non economic incentive to disclose (an idea) . . . Society does not, however, confer an economic reward because it fears that Einstein may somehow get a monopoly on e=mc² and whatever it might be applied to. . . . Both Einstein and society get some advantages and some disadvantages. ” [11.] The author of this expression is trying to convince us that people do not want E =mc² belonging to somebody personally. But the same can be said about patents and about any type of IP and tangible property [10]. I.e. the argument about Einstein's monopoly does not have any scientific grounds and rather is the result of political pressure from left-oriented people and their representatives.

### Why the IIPs Have to Be Better Protected

Let us analyze why in the modern science novel original ideas and proposals have to be much better protected. There are many reasons for that and some of them are as follows:

1. All scientific IlPs have independently existing their own value. The methodology to determine this value, at least in the very first approximation, practically does not exist. For many knowledgeable, intellectually advanced scientists it is very often enough to know only the idea in order to organize (if they have an access to resources) hundreds and may be thousands of small scale research works, which can easily be derived logically by them and many others from the original idea Very often in this situation all credits go to somebody who had only the resources to develop an idea, had developed it, but had not participated in its origination. The originator of an idea can get sometimes almost nothing.

2. The virtual and actual theft of ideas in science is a rather frequently occurring event [8]. No one had ever been punished for the theft of IIPs in science. Moreover, a lot of scientists received undeserved rewards and credits, leaving the real, genuine generator of idea (Gld) in the shadow [12]. Thus the existing system actually encourages scientists to steal ideas from each other. This is a very outrageous, ill and unfair asymmetry .... ideas are “routinely pirated” from research proposals by reviewers. This is a grave and blatant violation of professional ethics, with potential legal ramifications. But such charges are exceedingly difficult to investigate and substantiate [13].

3. When IIPs are not protected, the general visible picture of scientists' rank allocation is distorted dramatically in comparison with the real distribution of intellectual potential and efficiency of scientists, which is hidden, buried, and camouflaged. There is no way we can figure out precisely who is who in science and therefore what is what in ideas.

4. There are a lot of independent, maverick scientists, who have great ideas, but due to the fact that the science become a more closed enterprise they do not have any opportunity to develop them further. Their ideas are developed with much slower pace than ideas of somebody who has an access to the developmental resources.

5.The trade secret law of many countries protects very well all new IIPs generated by the employees of any enterprise and they can easily be protected within an enterprise to any required level. Any outsiders, independent scientists and inventors do not have this powerful instrument to protect their ideas.

6.The existing system of science organization and management provides less and less incentives for the GIds to generate new original ideas. The award system for GIds becomes more and more subjective, arbitrary, frivolous and irrelevant. In such a milieu they tend to become simultaneously outcasts and endangered species.

7.The inadequate system for idea protection ruins moral climate of scientific community, transforming it into “empire of lies”.

8. As it was mentioned by J. V. DeLong [10] :“The existence of [intellectual] property rights diffuses power. If resources are not owned, they will be allocated by the rules of politics, not by the rules of morality and economics.”

9.Sooner or later the process of moving the small-scale, well-structured scientific experimental work into third countries will be intensified exactly like it is happening at present with manufacturing of computers, electronics, cars and even with the software development. Under these circumstances new original ideas have to be much better protected worldwide, since most of them was and still is being created in developed countries.

11. Any idea is as distinguishable as a melody of music. As it is well known, based on any melody many new musical variations can be developed by many other composers. Nevertheless, in music all rights for any variations will be held by the originator of the first original melody. Copyright law protects any novel melody of music, hundreds of which can be created by anyone, but ideas are not protected. This strange asymmetry does not have any logical explanation and justification.

12. Ideas, as a rule, are generated individually by a single scientist or inventor. Therefore, if ideas are well protected by law we have much better chances of finding, elucidating and evaluating personal contribution of scientists.

13. The probability that a private investor would invest money into a raw idea and long-term research is much higher if scientific ideas are better protected. The science, under these conditions, can have much better chances for survival without federal financial support, endowments etc. to begin a new era, when the whole scientific enterprise is privatized.

14. Not less than businessman, entrepreneurs, actors, artists etc. good efficient scientists, Gld deserve to be millionaires and billionaires. No one scientists in the world yet become a billionaire but practically all existing billionaires organized their business based on the knowledge obtained by scientists during the last 100 -200 years.

### DETAILED DESCRIPTION OF BUSINESS METHOD

More detailed description of a new business method is disclosed further. At present, the authors of new scientific IIPs can submit their proposal to hundreds foundations, institutions, organizations, agencies in order to find money for their research. All of these agencies have different type of peer review systems and different lists of topics, which they consider for funding. Most of the peer review systems accepted by these funds distributing institutions are anonymous. Too many organizations supporting research means too much confusion for scientists and too much wasted time for writing proposals.“. . . I have certainly noticed changes over the years, both in the nature of the programs and the amount of work needed in raising sufficient funds to curry out research. The simple fact is that university chemists are spending too much of their time raising money. Indeed, this is a familiar complaint from almost all of the young (and older) scientists I know. Some claim they spend 70% of their time on fund raising, and if it so, it is a deplorable situation. ” [14]. One of the factor which leads to this deplorable situation is described very precisely by a well-known expression that the U.S. science is “pathologically decentralized”. This phenomenon does not have any coherent and logical explanation.

In this work it is suggested to introduce a novel open system, where only onymous preliminary evaluation of scientific merits of proposals or ideas will be performed. I.e. the evaluation of scientific merits of all IIPs of all scientists is suggested to perform in one private or federally owned an Internet connected company. Let us call this company Global Open Network for Experts (GLONEX).

The company can have an Internet connected database, where new IIPs can be submitted. Everybody who wants to have access to the database should agree to become a member of GLONEX. Any new well-accomplished or raw idea or hypothesis from anybody, not obligatory a member of GLONEX, can be submitted to the company database. Everybody who wants to be a member and to have an access to the database have to sign nondisclosure/nonusage agreement. According to this agreement, any info from the database cannot be disclosed to anybody, except to the members, used or explored by a member without permission of the author. All members are supposed to pay minimal membership fee and agree to follow ethical rules for members, they can have access to any IIP and any review about this IIP in the database. All members can be reviewers of any submitted IIP.

Any author can submit any number of IIPs. After that the IIPs are divided into two classes: certified and noncertified or raw IIPs. The IIP is considered certified if it is understood by at least one scientist-reviewer in the world and his evaluation is included into GLONEX database. The IIP understood by a reviewer means: the information provided by an author is sufficient in order to evaluate it on four parameters: 1) to conclude that it is scientifically correct or wrong; 2) novel or known, 3) obvious or nonobvious; and 4) it is worth or not worth to be studied further. If at least on one parameter the IIP is not evaluated it is considered noncertified.

There could be several scenarios after an IIP is submitted to the database. The first scenario is when an IIP does not produce any response from reviewers, i.e. it is not certified. It might be when it is wrong, no one is interested, no one understood or partially understood the IIP. An author of the raw IIP can write it more in detail to be more understandable and submit again to the database. It would be logical behavior for an author if he wants to send somewhere his idea for funding his idea have to be understood by at least one scientist.

Second. The IIP is certified by at least one scientist-reviewer. The author in this case can sent his idea or proposal with reviewer's comments to research supporting foundations. A funding organization, based on the rank of reviewer, can decide if the proposed research worth to be funded. The funding organization can reject entirely or conditionally the IIP if only one or several reviewers with dubious reputation support the proposal. The author might be asked to write his IIP more elaborate, more in detail to be understood by other reviewers.

Third. The IIP is understood by many high-ranking reviewers and evaluated as a promising with recommendation to be studied further. In this case, the IIP can be considered as worth to be sent for funding. The author can send it with GLONEX certificate to as many agencies as he wants.

Fourth. The IIP is understood by many reviewers and recognized as wrong or not worth to be studied further. In this case, it would not be worth sending the IIP to a funding institution. However, there is important difference between nowadays procedure for IIP acceptance and procedure described in this new method. According to this method, all reviews are expected to be completely open and all reviewers will be responsible during the whole period of work within GLONEX for all their reviews. If reviewers made many mistakes in evaluating IIPs their rank and their rewards from GLONEX will be diminished. Also will be diminished the value of any IIP which was certified by a reviewer. Under these conditions, for all reviewers it will always be beneficial to support good promising IIPs and to reject the ones that are wrong or not showing good potential. The author of a good but rejected IIP will have at least satisfaction that somebody who rejected his IIP are reprimanded or punished to some extend.

Fifth. The IIP has mixed response. Several good and several bad reviews. The author in this case should ether wait until the real value of IIP will be elucidated or risk and send it to an agency of his choice.

The authors have to pay a modest fee for the IIP submission and every year a fee for keeping the IIP in the database. The authors (Glds) will pay a certain fee to GLONEX for their IIP evaluation. To accelerate the process of IIP evaluation and in case if the author does not have the money to pay to reviewers he can write a promissory note and ask reviewers to examine his or her IIP on a contingency bases. Within GLONEX all rights for any IIP can be sold, licensed, or given for free entirely or partially by author to anybody including reviewers. Accepting membership in GLONEX every Old should also agree, if he asked for free evaluation of his IIP, a small part of his future royalties for IIPs have to be assigned for GLONEX.

To prevent from somebody sending too much scientific garbage, useless, wrong lips, the submission fee can be raised for them. All results of an IIP evaluation will be open only for GLONEX staff and members and will be considered as a GLONEX trade secret Also the database partially will be open to everybody, not only members, if GId would agree to provide partial or whole access to his IIPs for nonmembers. The rank of reviewers will be determined based on their right and wrong evaluations and the fate of the IIPs they examined. The reviewers can get maximum rank if in the first approximation the result of his evaluations correlates with results of the best, high ranking reviewers. His finale rank will be determined based on the number of accepted and rejected IIPs and how his evaluations correlate with real fate and value of IIPs in the future. The IIP is considered valuable if 1) it was developed further or used in any way not only by the author but also by other scientists in this or any other countries to produce a novel scientific knowledge derived from this IIP; 2) the scientific knowledge contained in the IIP is presented in scientific books and especially in the textbooks for students or used by teachers to teach students; 3) the IIP was commercialized, or was used to introduce a new or modified product or service on the market; generally speaking, if the IIP brought any tangible benefits for the people in this country or/and worldwide.

Based on any tip, hint or a new evidence reviewer can reverse or change their conclusions on any IIP any time. Their rank will be much worse if they did not notice (when everybody have noticed) that earlier rejected by them IIP was actually worth to be studied, patented and commercialized.

It is easy to understand that based on this system the rank of reviewers can be determined much faster (1-2 years) than in existing system, where it normally require at least 10 -15 years. GLONEX will accept the open innovation concept i.e. it will also accept novel nontrivial IIPs on a subject how to improve the efficiency, accuracy, speed in IIP evaluation. It is understandable that any novel and nonobvious IIP will not be used by GLONEX without permission of an author.

Loud scientific noise is not the only weapon which modem science uses against novel good IIPs. There is another one which is known as a “conspiracy of silence.” [3]. It's not uncommon that in the modem science something that is suggested by somebody who is not a well known top-notch scientist is kept for a long time in the shadow. The existence of this effect also can be attributed to the inadequate influence of subjective factor in science. For many scientists, especially for nontenured young university professors to start to develop an invisible in scientific circles IIP, which might be recognized in 10 -50 years, is with great probability to kill their scientific careers. Also, the existing scientific system practically does not provide any incentives for scientists-reviewers to support novel promising research. However, it provides many incentives and easy realizable opportunity to impede something new when this impediment is beneficial for them personally.

In the described new system, the fate of good, promising IIP is expected to be very different. Since GLONEX can offer a reward (or some share of potential revenue from IIPs) for recognizing their valuable IIPs, any reviewer will be tuned to discover and promote something really significant. In GLONEX every idea, invention or proposal will have open teams of their opponents and proponents. Another incentive for reviewers will be the fact that recognition of valuable IIPs and rejection of something what does not show potential benefits for the Investor and society will increase their rank.

To mitigate the fact that monopoly for a scientific IIP can, in principle, impede the scientific and economic progress, the government can offer to authors of valuable IIPs some sort of tenure position at a government sponsored scientific institution. This, in reality, might be virtual, Internet based institution. The actual place of work for scientists can be anywhere: university, private company, their own home or any place where they feel comfortable to work. All scientists, who obtain such tenure, will be obliged to disclose all their scientific findings into the public domain and they cannot prevent others to use their IIPs. Such type of tenure is radically different than a tenure-faculty at modem universities, but it is much more logical and rational. It will be given only to a person who might otherwise monopolize scientific knowledge impeding further scientific progress in some crucial areas of research. Awarding tenure in such a way for a university professor would also justify public financial support of scientific research at universities, because affiliated with universities authors would relinquish their rights for IIPs (which of course do not exist now) trading them for public money to conduct a research. It is clearly seen that in this case the career of scientists will depend only on their personal scientific contribution and would not depend on a huge number of subjective and irrelevant factors described above.

All IIPs entering GLONEX will be ranked and list of all of them can be presented, let us say, every month, every quarter, every half year, every year etc. They will be ranked according to their potential value assigned by reviewers. The best will be listed the IIPs or proposals which were recognized as such by the best high-ranking reviewers. The idea can have the highest rank if it is positively ranked by all reviewers.

The appearance in the modern scientific enterprise a company like GLONEX can move us considerably closer to the implementation of very often heard proposal about shared university facilities and industrialization of scientific experiment.“Universities should develop shared central facilities that are the common responsibilities of the faculty and the university. The nature of these facilities and the services they provide should reflect the faculty research needs shared facilities would give all faculty access to needed instrumentation, and would relieve them of burdensome efforts directed at obtaining and maintaining complex instrumentation[15]. ” May be not only in American but also in the whole world of science there exists a longstanding problem, that the number of IIPs which are necessary to check experimentally grow much faster that the ability of existing experimental enterprise to verify them. It is understandable for everyone that scientific experiment industrialization is the only option to solve this at least 20 -30 years old problem. The industrialization in this case means building not only universities' shared facilities but also rather large well-equipped experiment enterprises where experiments will be conducted mostly by professional world class let us say 100 - 300 experimentalists. Amazingly modem universities, spending more than 90% of all money for nonmilitary preapplied, fundamental and purposeful fundamental research practically do not have professional experimentalists in their scientific laboratories. Mostly graduate students and postdocs perform all experiments. Average graduate student, of course, is very far behind in productivity (not so rare orders of magnitude) and in the quality of work in comparison with the world-class experimentalists. Since professors have many students and they are extremely busy with their everyday routine the teaching of grad students-experimentalists is very often carried out by a little bit more senior grad students or by postdocs. Such type of teaching, of course, is not so beneficial for students [1,3]. Universities more concern about producing more and more Ph.D. then about productivity and quality of experimental scientific works which are conducted by them. Because of this gradually pro experimentalists have disappeared from universities and they also (likewise the GIds) become endangered species.

It needs to be clarified that the briefly described above new business method from the very beginning has to be supported financially by the government. The necessity of this support unavoidably follows from the fact that in the existing scientific enterprise novel original scientific results and ideass are practically not protected by the intellectual property (IP) law. Carefully analyzing how IP low is designed in modem free market countries it can be concluded that there is evident tendency: the better ideas and scientific results of scientists are protected the less public money are required for scientific research. If there exist 100% ownership for ideas and scientific results there is a chance and potentials in the future for 0% of government support of science; or if there is 0% ownership for ideas like it is now there must exist 100% support of all fundamental and preapplied science by the government with increased every year spending. Once again it needs to be emphasized that in existing modem scientific enterprise with existing IP law all scientific research, which is at the level when private investor feels that the risk is too high for funding, has to be funded by people money. Thus it can be speculated that science can be privatized in the best case may be in 20 -30 years only when there exist certain much higher level of IP protection. However, it is not clear yet how high this level has to be. To verify experimentally which minimal level of IP protection is needed is also one of the goal of a suggested in this invention new system for IIPs commercialization.

Yet another feature of this new system needs to be emphasized. From the moment when a new system is introduced the times will be gone forever when nobody is punished or/and responsible for dumping down novel, original, worth to be studied, beneficial for the Investor IIPs.

### Advantages of the Business Method.

There are numerous advantages of the proposed in this invention business method and system for the scientific ideas, proposals and inventions evaluation and commercialization

1. The system is absolutely not harmful to anybody. No one will be hurt from the old system. No one will be forcefully dragged into this new system. They can coexist together very peacefully. More over, existence of both systems will stimulate, accelerate positive changes and developments within each system. In the future they may be even converge.

2. For the first time in the history of science people can have limited ownership for their IIPs. Their ideas will be much better protected. If majority of GIds and reviewers will participate in GLONEX this virtual, limited ownership will become very close to wholly sustained ownership.

3. The evaluation of IIPs will be performed much faster and with better precision by ranked, professional reviewers.

4. For the first time in the history of science scholars can earn their living for only generating new scientific ideas, or for only evaluating them.

5. Scientists would have a more reliable feedback allowing them to understand rather quickly their errors and failures, orienting them towards more promising, more advanced scientific research.

6. Much greater degree of the science openness will be provided by a new system.

To understand these advantages more clearly lets us compare the features and differences of an old and a new system of science organization and management:

5.4. Old and new systems and methods comparison

| | Old System | New system |
|---|---|---|
| 1 | Mostly closed system sometimes even | Always open for everybody with useful IIPs and |
| | for established scientists. The principle | everybody who would like to review and evaluate the |
| | “equal opportunity for equally good | IIPs and scientific proposals. Perfectly accepts and |
| | scientific ideas” is not known here and | realizes the principle “equal opportunity for equally |
| | not accepted. | good scientific ideas” |
| 2 | In most cases can not reward scientists | Can reward separately for any personal scientific |
| | separately for their scientific | achievements, inventions, ideas, reviews, experiments, |
| | achievements, inventions, ideas, | theories etc. |
| | reviews, experiments, theories etc. It is | |
| | not very rare that the reward goes to a | |
| | figureheads who did not participate in a | |
| | project as a scientist. | |
| 3 | The career and reward of scientists | The career and rewards of scientists depends only on |
| | very often depends on numerous | the real value of their personal scientific contribution. |
| | irrelevant and subjective factors. | |
| 4 | There is no objective, generally | Accepts only objective criteria for evaluation of |
| | accepted, coherent, logical criteria | proposals and ideas. |
| | how to evaluate the ideas and scientific | |
| | proposals. Many criteria are purely | |
| | emotional and subjective. | |
| 5. | Any new ideas can be used, developed, | Ideas can not be used, developed, explored without |
| | explored without author permission. | author permission. Within GLONEX the ownership |
| | There is no institution of ownership for | for ideas will be established during lifetime of the |
| | ideas. | owner plus predetermined number of years. |
| 6 | Practically does not allow the existence | Scientists can have choice to work as independent |
| | of independent GIds, reviewers, and inventors. | GId, reviewers, experimentalists etc. Independent |
| | GIds become endangered | GIds can survive. |
| | species. | |
| 7 | Small-scale experiments are mostly | Even small-scale experiment can be performed in |
| | performed in poorly equipped | relatively large well-equipped experiment-enterprises. |
| | university laboratories. | |
| 8 | Practically there are no professional | Most complex experiments are performed by |
| | experimentalists (may be only in high | professional experimentalists with or without help of |
| | energy and nuclear physics). Not very | postdocs/students. |
| | rare even complex experiments are | |
| | performed by graduate students and | |
| | postdocs. Pro-experimentalists become | |
| | endangered species. | |
| 9 | Very poor precision in establishing the | Time dependent rank of every scientist, GId and |
| | rank of every scientist, GId and | reviewers is established more precisely. |
| | reviewers. | |
| 10 | Large grants to perform research. | Allow not only large grants but also small grants to |
| | Principal Investigator (P.I.) can | perform only one experiment. Most experiments are |
| | practically direct his research wherever | performed by two or more independent groups from |
| | he wants without any external control. | different experiment-enterprise. |
| | Practically all experiments are | |
| | performed by one lab in one university. | |
| 11 | Does not allow coexistence of old and | Does allow coexistence of old and any number of new |
| | new system or systems of science | systems of science organization and the systems for |
| | management. | ideas commercialization. |
| 12 | Most of the IIPs are not ranked and | All IIPs are ranked by certified reviewers according to |
| | randomly developed. | their potential scientific value and potential for |
| | | commercialization. |
| 13 | Proposal for a research involving | Proposals and ideas can be sent by anyone. |
| | experiment can be sent only by a | |
| | person who has access to certain | |
| | resources to conduct experiments. | |
| 14 | Practically there is no information | After evaluation by multiple reviewers every idea, |
| | regarding majority of IIPs in science | invention proposal will have open teams of opponents |
| | who is its opponent and who is | and proponents. |
| | proponent. | |

May be the most important advantage of this new system is the fact that it does not matter from the very beginning what project or idea are suggested to improve the existing scientific enterprise. This new system can find out much faster a right model for scientific research policy no matter where we are lost at present is the jungles of modern science management system. I.e. the new system has a very great potential for self-improvement.

### REFERENCES

1. C. J. Sykes, Profscam: Professors and the Demise of Higher Education, St. Martin's Press, New York, 1988.

2. G. S. Khromov, The science which we are loosing, Kosminform, Moscow, 1995.

3. M. Anderson, Impostors in the temple. A Blueprint for Improving Higher Education in America, Hoover Institution Press, Stanford University, Stanford, Calif. 1996.

4. D. Shapley, R. Roy, Lost at the Frontier. U.S. science and technology Policy Adrift,ISI Press, Philadelphia, 1985

5. S. Rojstaczer, Gone for Good Tales of University Life after the Golden Age, Oxford University Press, 1999.

6. C. J. Lucas, Crisis in the Academy, Rethinking higher education in America. Si. Martin's Press, New York, 1996.

7. E. L. Belilovsky, B. S. Rozov, Yu. V. Chetverikov, Centralized Registration of Scientific Results, ECQ (Russ), #6, p.188 -193, 1986.

8. M. C. Lafollette, Stealing into Print, Fraud, Plagiarism, and Misconduct in Scientific Publishing, University of California Press, Berkeley, Los Angeles, Oxford, 1992

9. D. Goodstein, J. Woodward, Inside Science, The American Scholar, V. 68, #4, p.83-90, 1999.

10. Copy Fights. The future of intellectual property in the information age,Edited by A. Thierer, W. Crews. Cato Institute , 2002.

11. G Hammond, The Legal Protection of ideas, Osgoode Hall Law Journal, #1, v.29, p.93 -125, 1991.

12. W. Lanouette, B. Silard, Genius in the Shadows. A Biography of Leo Szilard. The Man Behind the Bomb. Carles Shribner's Sons, Macmillan Publishing Company, New York, 1992.

13. D. E. Chubin, E. J. Hackett, Peerless science, State University of New York Press, 1990.

14. A. J. Bard, Politics, culture, and science: the golden age revisited, Chemical and Engineering News, Apr. 8, 2002, p. 44-47.

15. H. K. Birnbaum, A Personal Reflection on University Research Funding, Phys. Today, Mar. 2002, p.49-53.

16. G. Miller, Academy: UF (University of Florida) striving to improve totals, Gainesville Sun, Mar. 30,2002.

17. The Questions of Tenure, edited by R. P. Chait, Harvard University Press, Cambridge, 2002.

18. B. Bayh, Remarkable Benefits, Remarkable Breakthroughs, The National Journal of Technology Commercialization, Apr.-May, 2005, p.29.

1. A method for scientific idea, inventions and proposals (IIP) commercialization,
said method comprising the steps of providing a web site over global computer networks
(GCN), which is owned by IIPs evaluating, marketing and commercializing entity.

2. Any said IIPs from anybody can be submitted and included in a database of said GCN. Admission for familiarizing with IIPs from said web site and to evaluate and review any them is open to anybody who will recognize and agree to follow said entity ethical rules and sign a nondisclosure/nonusage agreement regarding any information from said web sites. Everyone agrees not to explore any IIP, not to disclose to anyone without permission of the author of the IIP or said entity.

3. Within the said entity said author of IIPs have all exclusive rights and ownership during predetermined period of time.

4. Said predetermined time will last life time of the author plus predetermined number of years.

5. Authors of said IIPs will be free to sell, to disclose, to patent, to gift or endow them.

6. All said IIPs evaluated by reviewers as novel or not novel, obvious or not obvious, and if it is worth or not worth to study or develop them further.

7. Said IIPs have highest rank if it is evaluated positively by reviewer or revivers with highest rank.

8. Said preliminary rank of the reviewer will be determined based on correlation of the results of his review with results and opinions of previously certified reviewers and the experts, and said finale rank of the reviewer will be determined based on objective data of regarding the finale fate of said IIP.
